(19) United States
(12) Patent Application Publication
(10) Pub. No.: US 2013/0286436 A1
(43) Pub. Date: Oct. 31, 2013

(54) IMAGE PROCESSING APPARATUS, METHOD FOR CONTROLLING THE SAME, AND STORAGE MEDIUM

(71) Applicant: CANON KABUSHIKI KAISHA, Tokyo (JP)

(72) Inventor: Masanobu Inui, Chigasaki-shi (JP)

(21) Appl. No.: 13/868,820

(22) Filed: Apr. 23, 2013

(30) Foreign Application Priority Data
Apr. 26, 2012 (JP) 2012-100973

(51) Int. Cl. G06K 15/02

(52) U.S. Cl. CPC G06K 15/02
USPC 358/1.15

(57) ABSTRACT

A method for enabling a user to add page numbers to a specific range designated by the user from a plurality of pages is provided. The method for controlling an image processing apparatus for processing images of a plurality of pages includes determining a start page of page number from the plurality of pages according to a user instruction, determining an end page of the page number from the plurality of pages according to a user instruction, and performing a control to add page numbers based on the start page and the end page.

### BACKGROUND OF THE INVENTION

1. Field of the Invention

The present invention relates to an image processing apparatus, a method for controlling the image processing apparatus, and a storage medium.

2. Description of the Related Art

It is conventionally known that an image processing apparatus can allocate (add) a page number to image data. For example, such an image processing apparatus stores image data including ten pages and allocates serial page numbers “1” to “10” to the first through tenth page image data.

Further, a conventional image processing apparatus discussed in Japanese Patent Application Laid-Open No. 2007-258859 can read a plurality of document bundles and allocates serial page numbers to the read document bundles.

However, the above-mentioned conventional image processing apparatuses do not enable users to instruct a start page, which is selectable from a plurality of pages of the image data, to start page number allocation.

For example, when a user wants to add a cover and an index page to a document image, the user may want to allocate page numbers to all of the added pages in addition to original document pages or may want to allocate page numbers to the index page without allocating a page number to the cover. Further, the user may want to allocate page numbers to the original document pages only without allocating any page numbers to the cover and index pages. However, the above-mentioned conventional image processing apparatuses do not have any capability of realizing the above-mentioned user's requirements.

### SUMMARY OF THE INVENTION

According to an aspect of the present invention, an image processing apparatus for processing images of a plurality of pages includes a first determining unit configured to determine a start page of page number allocation from the plurality of pages according to a user instruction, a second determining unit configured to determine an end page of the page number allocation from the plurality of pages according to a user instruction, and a control unit configured to perform control to allocate page numbers in a range defined by the start page determined by the first determining unit and the end page determined by the second determining unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image processing apparatus according to an exemplary embodiment.

FIG. 2 is a block diagram illustrating a configuration of an image processing apparatus according to an exemplary embodiment.

FIG. 3 is a cross-sectional view illustrating an image processing apparatus according to an exemplary embodiment.

FIG. 4 illustrates a configuration of an operation unit according to an exemplary embodiment.

FIGS. 5A and 5B illustrate operation screens according to an exemplary embodiment.

FIGS. 6A and 6B illustrate operation screens according to an exemplary embodiment.

FIGS. 7A and 7B illustrate operation screens according to an exemplary embodiment.

FIGS. 8A and 8B illustrate operation screens according to an exemplary embodiment.

FIG. 9 illustrates an operation screen according to an exemplary embodiment.

FIG. 10 illustrates an operation screen according to an exemplary embodiment.

FIGS. 11A to 11F illustrate examples of page number allocated image data.

FIG. 12 is a flowchart illustrating a control example according to an exemplary embodiment.

FIGS. 13A and 13B illustrate operation screens according to an exemplary embodiment.

FIG. 14 illustrates an operation screen according to an exemplary embodiment.

FIGS. 15A to 15E illustrate examples of page number allocated image data.

FIG. 16 is a flowchart illustrating a control example according to an exemplary embodiment.

FIG. 17 illustrates an operation screen according to an exemplary embodiment.

FIGS. 18A to 18F illustrate examples of page number allocated image data.

### DESCRIPTION OF THE EMBODIMENTS

Various exemplary embodiments, features, and aspects of the invention will be described in detail below with reference to the drawings.

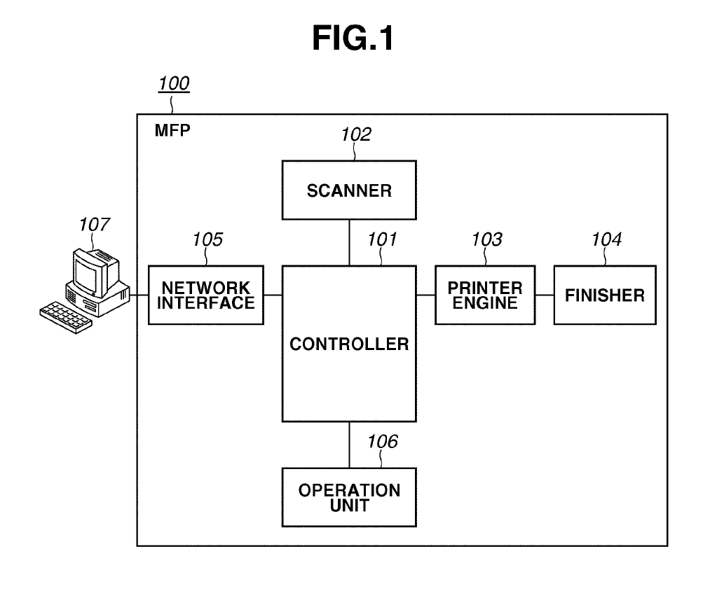

FIG. 1 illustrates a configuration of a multi-function peripheral (MFP) 100, as an example of an image processing apparatus according to a first exemplary embodiment of the present invention.

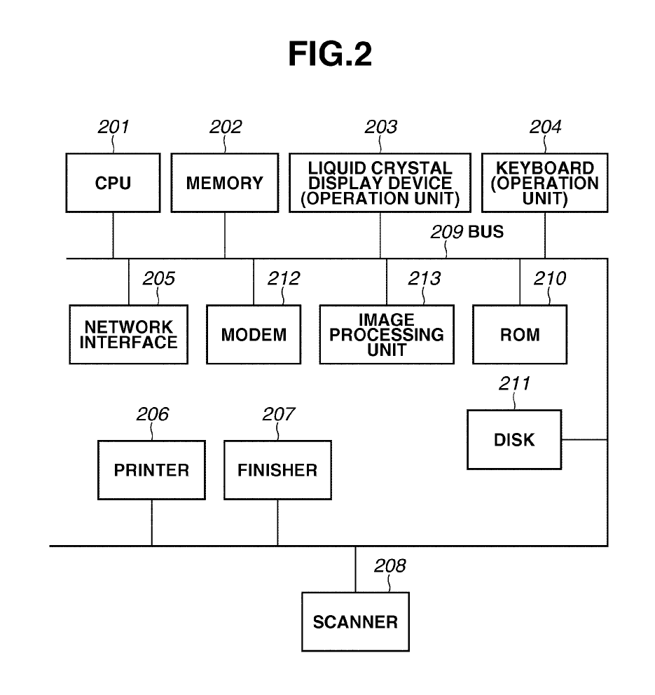

In FIG. 1, a controller 101 can comprehensively control various operations to be performed by the MFP 100. The controller 101 is described in detail below with reference to FIG. 2.

A scanner 102 can read an image from a document and can generate image data.

A printer engine 103 includes a sheet feeding cassette and an image forming unit. The sheet feeding cassette can supply a sheet and the image forming unit can print an image on the supplied sheet.

A finisher 104 can perform post-processing on a sheet on which an image is printed by the printer engine 103. The post-processing that can be performed by the finisher 104 includes such as staple, punch, and shift processing.

A network interface 105 can control data communications to be performed between the MFP 100 and an external personal computer (PC) 107 via a network. The MFP 100 can also communicate with another MFP or a server via the network interface 105.

An operation unit 106 includes a liquid crystal display (LCD) device, which includes a touch panel sheet, and hard keys. The LCD display device including the touch panel sheet can display an operation screen to receive operational instructions from a user via the touch panel sheet and transmit the received instructions to the controller 101.

FIG. 2 illustrates a hardware configuration of the MFP 100 illustrated in FIG. 1.

The controller 101 includes a central processing unit (CPU) 201, a memory 202, a liquid crystal display device 203, a keyboard 204, a network interface 205, a read only memory (ROM) 210, and a DISK 211 which are connected via a bus 209.

The CPU 201 can transmit and receive data to and from each unit via the bus 209, to comprehensively control the operations to be performed by the MFP 100.

The memory 202 is functionally operable as a work area for the CPU 201. The memory 202 can be constituted by a nonvolatile memory, such as a dynamic random access memory (e.g., DRAM) or can be constituted by a volatile memory, such as a static random access memory (e.g., SRAM), or can be a combination of DRAM and SRAM.

The liquid crystal display device 203 and the keyboard 204 constitute the operation unit 106 illustrated in FIG. 1.

The liquid crystal display device 203 stores display data transmitted from the CPU 201 in a memory (not illustrated) and can display various screens based on the stored image data. Further, the liquid crystal display device 203 includes a touch panel sheet which enables a user to input an operation. The liquid crystal display device 203 can transmit a signal indicating the input operation to the CPU 201.

The keyboard 204 includes hard keys (e.g., a start key, a stop key, and a numeric keypad). The keyboard 204 can receive an operation input by a user, and can transmit a signal indicating the input operation to the CPU 201.

The CPU 201 performs processing according to signals received from the liquid crystal display device 203 and the keyboard 204.

The network interface 205 corresponds to the network interface 105 illustrated in FIG. 1 which can control data communications to be performed between the MFP 100 and the external PC 107.

The ROM 210 stores various programs and data pieces read by the CPU 201.

The DISK 211 stores various programs and data pieces read by the CPU 201. For example, image data can be stored in the DISK 211.

A modem 212 can control facsimile communications to be performed between the MFP 100 and an external apparatus via a telephone line.

An image processing unit 213 can perform various image processing, including rotation of image data, allocation of page numbers to image data, allocation of date, allocation of stamp, and combination of image data with other image data.

In addition to the above-described units, a printer 206, a finisher 207, and a scanner 208 are connected to the bus 209. The printer 206, the finisher 207, and the scanner 208 correspond to the printer engine 103, the finisher 104, and the scanner 102 illustrated in FIG. 1.

The CPU 201 can perform various jobs including a copy job, a print job, a FAX transmission job, a FAX reception job, a scan transmission job, and a scan storing job, using the above-described configuration.

The copy job is a job that causes the scanner 208 to read an image from a document to generate image data and then causes the printer 206 to print an image on a sheet based on the generated image data.

The print job is a job that causes the network interface 205 to receive page description language (PDL) data from an external PC or another MFP to analyze and rasterize the PDL data and then causes the printer 206 to print an image on a sheet based on the generated image data. The print job can be a BOX print job that causes the printer 206 to print an image on a sheet based on image data stored in the DISK 211 according to an instruction from the operation unit 106.

The FAX transmission job is a job that causes the scanner 208 to read an image from a document to generate image data and then causes the modem 212 to transmit a facsimile to an external apparatus based on the generated image data.

The FAX reception job is a job that causes the modem 212 to receive a facsimile from an external apparatus and then causes the printer 206 to print an image on a sheet based on the received image data.

The scan transmission job is a job that causes the scanner 208 to read an image from a document to generate image data and then causes the network interface 205 to transmit the generated image data to an external apparatus.

The scan storing job is a job that causes the scanner 208 to read an image from a document to generate image data and then causes the DISK 211 to store the generated image data therein. The scan storing job can be a job that causes the scanner 208 to read an image from a document to generate image data and then causes a removable memory of the MFP 100 to store the generated image data therein.

As described above, the CPU 201 of the MFP 100 can execute various jobs. If a job for printing an image on a sheet includes execution of post-processing by the finisher 104, the CPU 201 executes the job and causes the finisher 104 to execute post-processing on the image printed sheet.

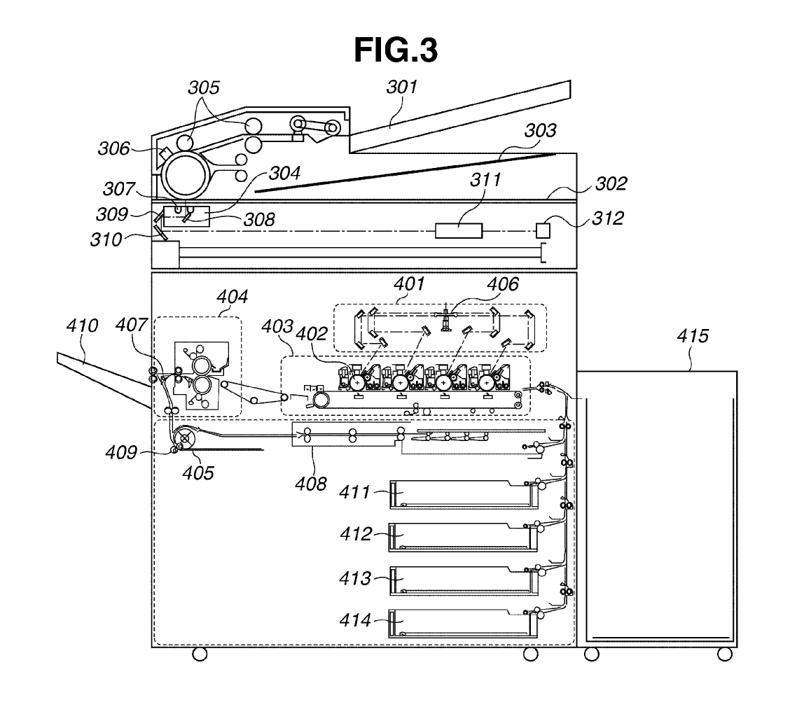

Next, a configuration of the MFP 100 according to the present exemplary embodiment is described below with reference to FIG. 3.

FIG. 3 is a cross-sectional view illustrating a configuration of the MFP 100. The MFP 100 includes a scanner unit and a printer unit.

The scanner unit includes an automatic document feeder 301 (ADF) that successively conveys document sheets stacked thereon one by one, from a leading page according to loading order, to a document skimming-through position. Subsequently, each conveyed document sheet is scanned at the document skimming-through position and discharged to a document discharge tray 303.

On a conveyance path through which a document sheet is guided, there are provided conveyance rollers 305 which are driven by a stepping motor and a document detection sensor 306 which detects a leading edge and a trailing edge of the document being guided.

Each document sheet stacked on the automatic document feeder 301 is conveyed by the conveyance rollers 305 driven by the stepping motor and passes through the document skimming-through position at a constant speed. In this case, an optical unit 307 moves to the document skimming-through position and irradiates the document sheet being conveyed at the constant speed with light emitted from a light source. The light reflected from the document sheet passes through a plurality of mirrors 308, 309, and 310 and a lens 311 and then enters a charge-coupled device (CCD) image sensor (hereinafter, referred to as “CCD”) 312 that includes color separation filters. Thus, a scanned document image is color separated and read by the CCD 312. Image data for each color of red, green, and blue (R, G, and B) is generated by the CCD 312 that occasionally performs reading. The image data is then transferred to an MFP control unit.

The printer unit includes four developing units to form cyan (C), magenta (M), yellow (Y), and black (K) toner images, respectively, to form color images and monochrome images.

The printer unit includes a laser exposure unit 401, a rotating polygon mirror 406, photosensitive drums 402, an image forming unit 403, a fixing unit 404, a flapper 407, a reversing path 405, rollers 409, and a two-sided conveyance path 408. Further, the printer unit includes sheet feeding cassettes 411 to 415. The sheet feeding cassette 415 may be referred to as a sheet feeding deck.

The laser exposure unit 401 delivers a light beam (e.g., a laser beam) modulated based on image data to the rotating polygon mirror 406 which is rotating at a constant angular velocity, in such a way as to irradiate the photosensitive drum 402 with scanning light reflected by the rotating polygon mirror 406.

The image forming unit 403 causes the photosensitive drums 402 to rotate and to be charged by a charging unit. Then, latent images formed by the laser exposure unit 401 on the respective photosensitive drums 402 are developed with toner. Then, the image forming unit 403 transfers the toner images to a printing sheet and collects the toner remaining on the photosensitive drum 402 without being transferred to the printing sheet. Accordingly, the image forming unit 403 can realize sequential electrophotographic processes with four developing units (i.e., developing stations). First, the cyan developing unit starts an image forming operation among four developing units of cyan (C), magenta (M), yellow (Y), and black (K) which are disposed in this order. After a predetermined time has elapsed after the cyan developing unit has started the image forming operation, the magenta, yellow, and black developing units successively start image-forming operations. The image forming unit 403 controls the timing of the image-forming operations, so that color images can be transferred on the printing sheet without causing any color misregistration.

The fixing unit 404 is constituted by a combination of rollers and belts, and includes a built-in heat source (e.g., a halogen heater). The fixing unit 404 heats and presses the toner on the printing sheet on which a toner image has been transferred by the image forming unit 403 to fuse and fix the image.

Each of the sheet feeding cassettes 411 to 415 store sheets. The MFP 100 supplies a sheet from any one of the sheet feeding cassettes 411 to 415 and conveys a supplied sheet to the image forming unit 403 with a conveyance belt. The MFP 100 transfers an image formed by the image forming unit 403 to the conveyed sheet. Then, the MFP 100 causes the fixing unit 404 to fix the transferred image on the sheet. In a case of face-down sheet discharge, namely when the MFP 100 outputs a sheet with an image formed side that faces downward, the MFP 100 causes the flapper 407 to guide the sheet along the reversing path 405 and output the reversed sheet to a sheet discharge tray 410. On the other hand, in a case of face-up sheet discharge, namely when the MFP 100 outputs a sheet with an image formed side that faces upward, the MFP 100 directly outputs the sheet to the sheet discharge tray 410 without causing the flapper 407 to guide the sheet into the reversing path 405.

When the MFP 100 prints images on both surfaces of a sheet, the flapper 407 guides the sheet to the reversing path 405 to cause the rollers 409 to sandwich a trailing edge of the sheet. The sheet is then guided to the two-sided conveyance path 408. The sheet guided to the two-sided conveyance path 408 is again conveyed to the image forming unit 403. The image forming unit 403 prints an image on a back surface of the sheet. After the image is printed on the back surface, the sheet is then output to the sheet discharge tray 410.

As described above, the MFP 100 can print a color image on a sheet. When the MFP 100 prints a monochrome image on a sheet, the MFP 100 drives only the black developing unit of the image forming unit 403 to print an image with the black toner on a sheet supplied from any one of the sheet feeding cassettes 411 to 415.

A sheet detection sensor is provided in each of the sheet feeding cassettes 411 to 415 to detect a remaining amount of sheets in each sheet feeding cassette (in a container). The CPU 201 receives a signal from each sheet detection sensor to acquire information indicating sheet remaining amounts of respective sheet feeding cassettes 411 to 415.

The MFP 100 according to the present exemplary embodiment is not limited to the above-described electrophotographic type and can employ an inkjet type to perform print processing.

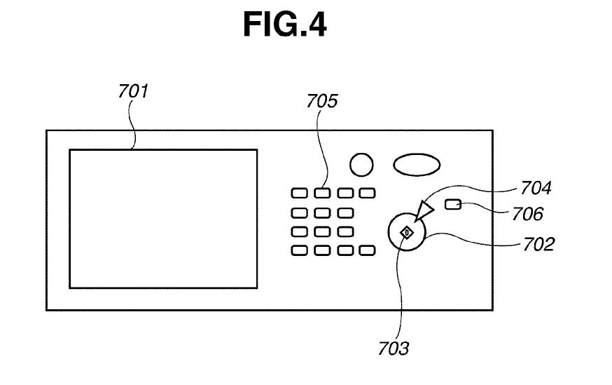

Next, a configuration of the operation unit 106 is described below with reference to FIG. 4.

A liquid crystal display unit 701 which is covered with a touch panel sheet can display operation screens and a state of the MFP 100.

A start key 702 is operable to receive a job execution start instruction. When the start key 702 is pressed, the MFP 100 starts the scan job, the scan transmission job, or the BOX print job.

A two-color (e.g., green and red) light-emitting diode (LED) 703 is provided at a central portion of the start key 702. The color of the LED 703 indicates a usable state of the start key 702.

A stop key 704 is operable to stop a currently executed job.

A numeric keypad 705 includes a plurality of numerical keys and a plurality of character keys which enables a user to set a numerical value indicating the number of copies.

A user mode key 706 is operable to perform device settings for the MFP 100.

The MFP 100 including the above-described configuration has a function of reading an image from a document and adding a page number to generated image data. Further, the MFP 100 has a function of receiving image data from an external PC and adding a page number to the received image data.

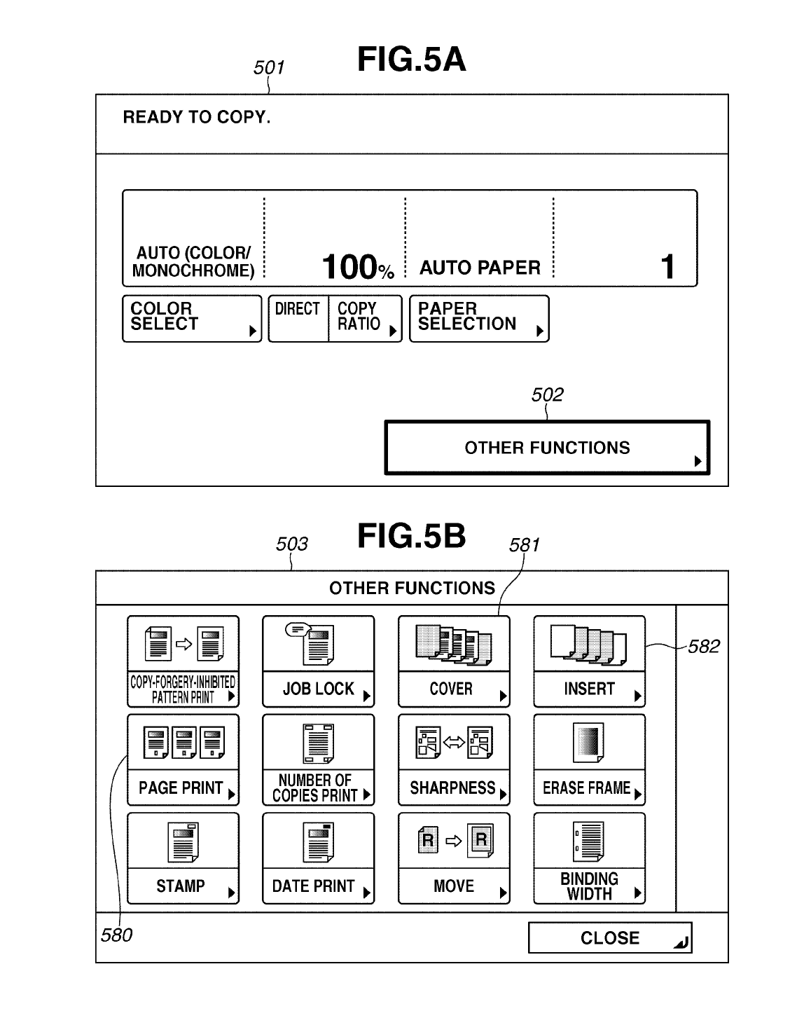

A setting for adding a page number is described in detail below with reference to FIGS. 5A and 5B.

A screen 501 illustrated in FIG. 5A is an initial screen to be displayed on the operation unit 106. The initial screen enables a user to perform setting for a copy job. For example, the user can set a copy ratio and a sheet to be used in a copy operation, or select a sheet feeding cassette.

An application mode button 502 enables a user to perform various functional settings.

If the application mode button (i.e., other functions button) 502 is pressed, a screen 503 illustrated in FIG. 5B can be displayed on the operation unit 106.

The screen 503 enables a user to perform detailed settings for various functions, including a “copy-forgery-inhibited pattern print” function, a “cover” function, an “insert sheet” function, a “page print” function, and the like.

When a user presses a “page print” key 580, the operation unit 106 can display a screen that enables the user to perform detailed settings for the “page print” function.

When a user presses a “cover” key 581, the operation unit 106 can display a screen that enables the user to perform settings for front and back covers.

When a user presses an “insert sheet” key 582, the operation unit 106 can display a screen that enables the user to perform settings for an insert sheet (e.g., interleaf).

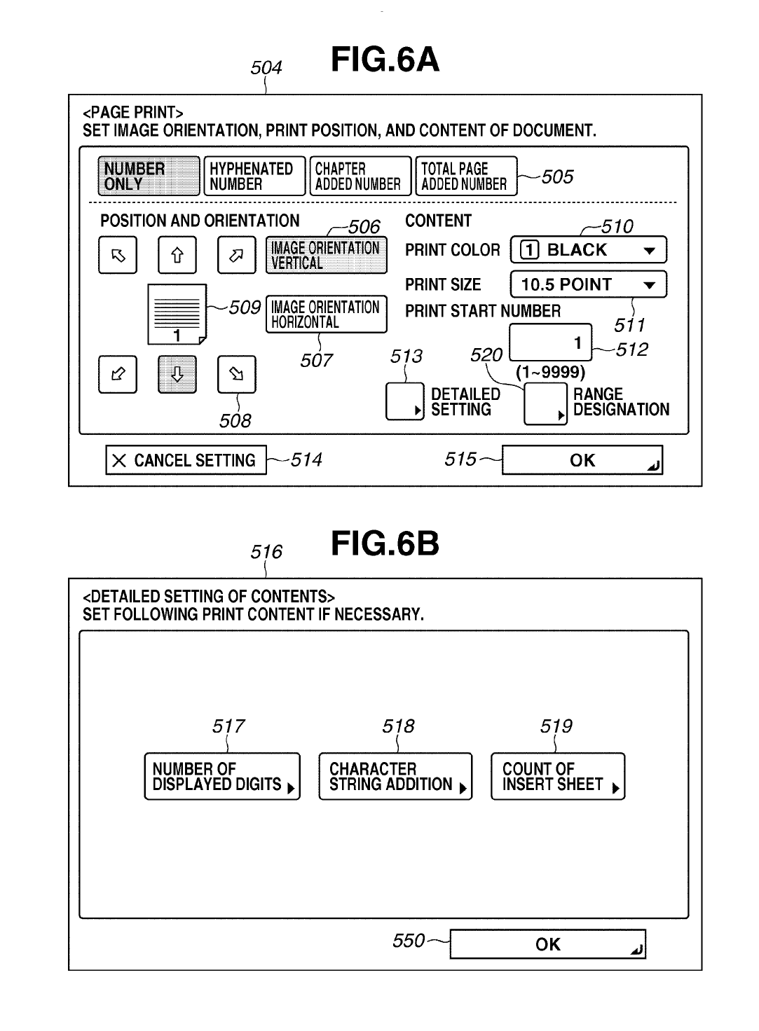

FIG. 6A illustrates a screen 504 that can be displayed on the operation unit 106 when the “page print” key 580 is pressed.

A button group 505 includes a plurality of buttons that enable a user to set a page print type. The user can select any one of “number only”, “hyphenated number”, “chapter added number”, and “total page added number” buttons from the button group 505.

The screen illustrated in FIG. 6A indicates a state where the “number only” button is selected because the color of the “number only” button is turned.

An “image orientation vertical” button 506 and an “image orientation horizontal” button 507 are buttons for setting the orientation of characters to be added in a page printing operation. A user can select the vertical direction or the horizontal direction.

“Print position setting” buttons 508 are operable to set the print position of each page number. More specifically, a user can set the print position of each page number by pressing any one of “upper left”, “top”, “upper right”, “lower left”, “bottom”, and “lower right” arrow buttons.

In the example illustrated in FIG. 6A, the “bottom” arrow button is currently selected. Therefore, an output image 509 displays the print position of the page number at the center.

A “print color” menu 510 is a menu for setting a color. When the “print color” menu 510 is pressed by a user, a pull-down list of a plurality of colors can be displayed. Thus, the user can select a color for each page number from the displayed list.

A “print size” button 511 is a button that is operable to designate the size of each page number. When the “print size” button 511 is pressed by a user, a pull-down list of a plurality of point values can be displayed. Thus, the user can select a size of each page number from the displayed values.

A “print start number” input area 512 is an area that is operable to designate a print start number. The print start number is a start value of the page number to be printed. The page number being successively incremented can be printed based on a value set in the “print start number” input area 512. After selecting the “print start number” input area 512, a user can designate a print start number by operating the numeric keypad 405. For example, when the designated print start number is 3, the CPU 201 performs a control to start adding the page number with 3.

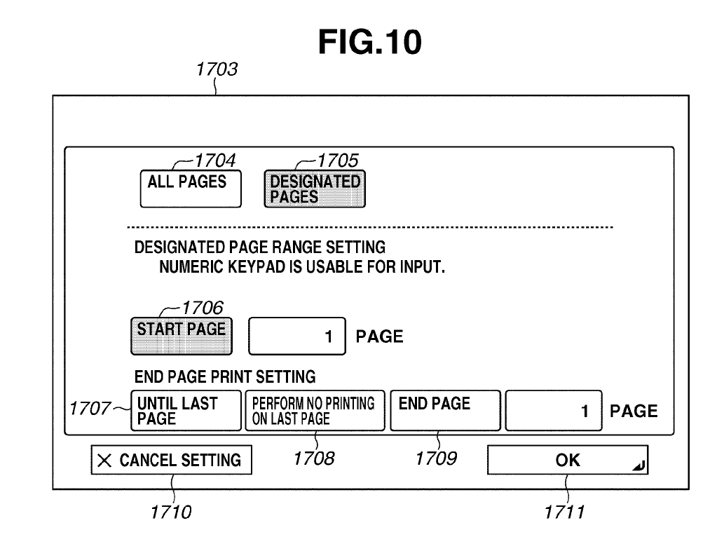

A “range designation” button 520 is operable to designate addition of the page number to a sheet to be printed. When the “range designation” button 520 is pressed, a screen 1703 illustrated in FIG. 10 can be displayed on the operation unit 106. The screen 1703 illustrated in FIG. 10 is described in detail below.

A “detailed setting” button 513 is operable to set details about a page print operation. If the “detailed setting” button 513 is pressed, a screen 516 illustrated in FIG. 6B can be displayed on the operation unit 106.

An OK button 515 is operable to enable the content set via the screen illustrated in FIG. 6A and terminate the display of the screen illustrated in FIG. 6A.

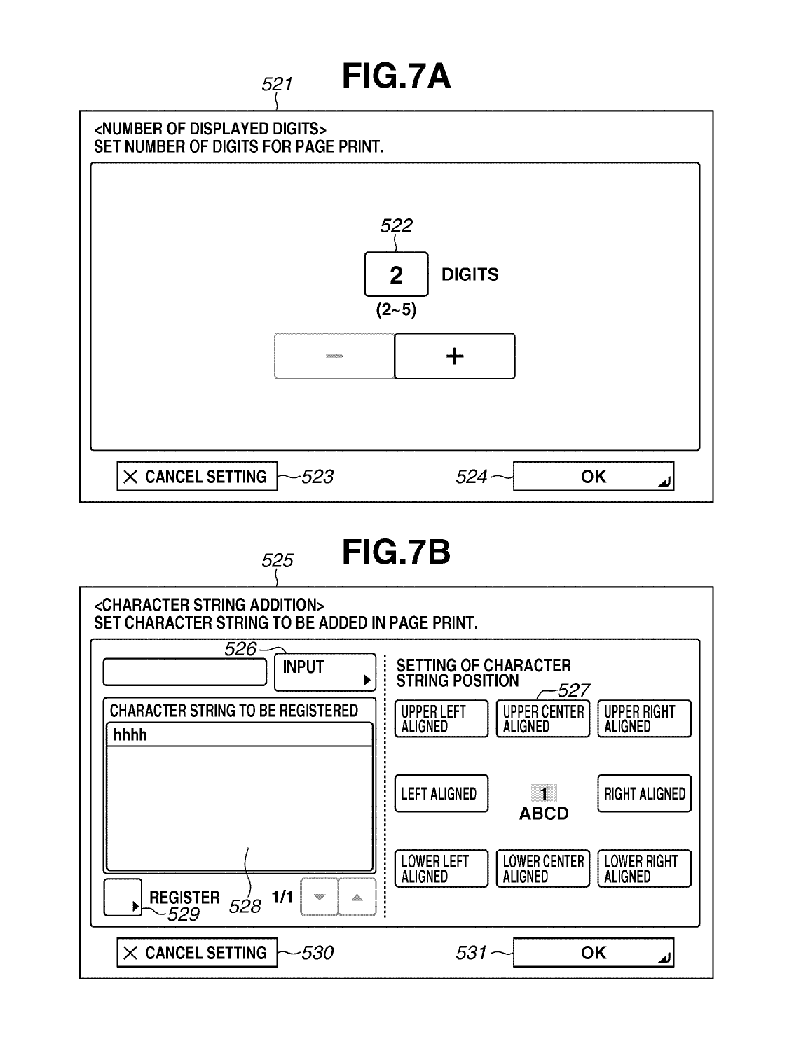

The screen 516 illustrated in FIG. 6B includes a “number of displayed digits” button 517 which is operable to set the number of digits for the page number. An initial value being set as the number of digits for the page number is one digit. If the “number of displayed digits” button 517 is pressed, a screen 521 illustrated in FIG. 7A can be displayed on the operation unit 106.

The screen 521 illustrated in FIG. 7A includes a “digit” input area 522, which enables a user to input a numerical value indicating the number of digits for the page number. After selecting the “digit” input area 522, a user can increase or decrease the numerical value using a plus key or a minus key. For example, when the number of digits set for the page number is “2”, the format of the page numbers to be added is “01”, “02”. When the number of digits set for the page number is “3”, the format of the page numbers to be added is “001”, “002”. A “cancel setting” button 523 is operable to reopen the screen 516 illustrated in FIG. 6B, without enabling the value set in the “digit” input area 522. An “OK” button 524 is operable to enable the value set in the “digit” input area 522 and then reopen the screen 516 illustrated in FIG. 6B.

The screen 516 illustrated in FIG. 6B further includes a “character string addition” button 518 which is operable to add a character string near the page number. If the “character string addition” button 518 is pressed, a screen 525 illustrated in FIG. 7B can be displayed on the operation unit 106.

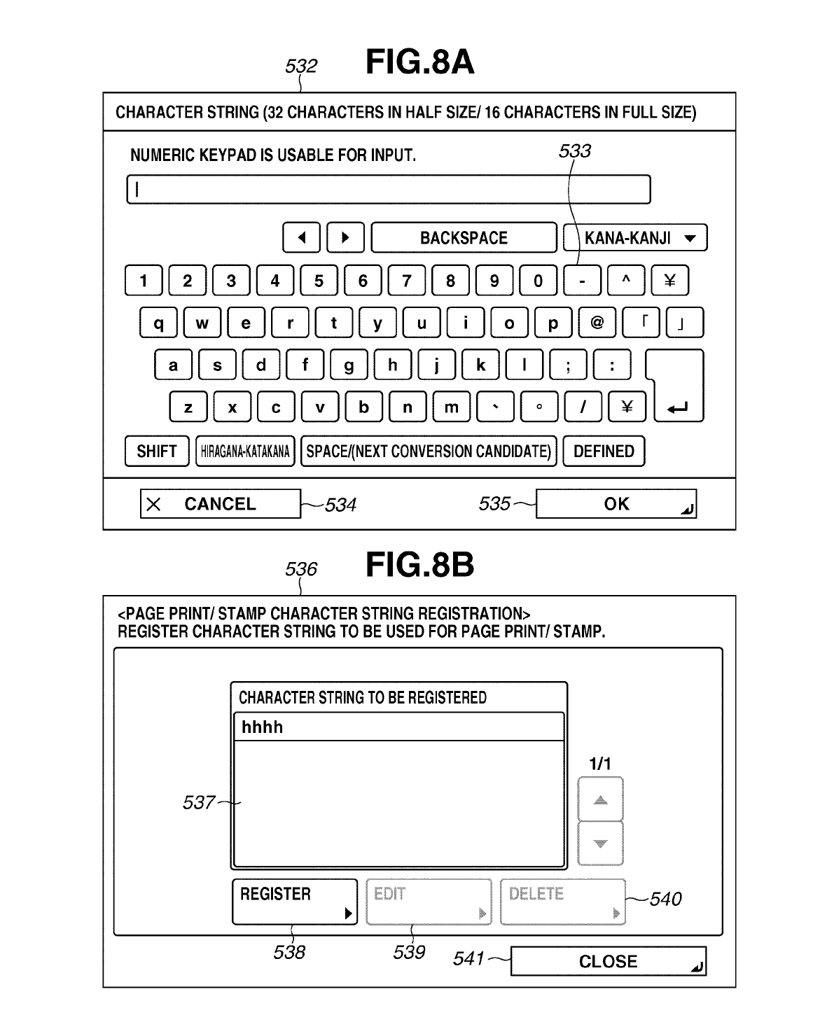

The screen 525 illustrated in FIG. 7B includes an “input” button 526, which is operable to designate a character string to be added near the page number. If the “input” button 526 is pressed, a character string input screen 532 illustrated in FIG. 8A can be displayed on the operation unit 106. The screen 532 includes a soft keyboard 533 that enables a user to input an arbitrary character string. If the user wants to cancel the input character string, the user can press a “cancel” button 534. If the user wants to enable the input character string, the user can press an “OK” button 535. If the “OK” button 535 is pressed, the screen 525 can be displayed again on the operation unit 106.

A registration character string display area 528 is an area in which an already registered character string can be displayed. A “register” button 529 is operable to add a registered character string. If the “register” button 529 is pressed, a screen 536 illustrated in FIG. 8B can be displayed on the operation unit 106.

If a “register” button 538 is pressed, the screen 536 illustrated in FIG. 8B can be displayed on the operation unit 106 and a character string set by a user via the screen 536 can be registered, and the registered character string can be displayed in an area 537.

If the user selects a character string in the area 537 and presses an “edit” button 539, the user can edit the already registered character string without opening the screen 532.

If the user selects a character string in the area 537 and presses a “delete” button 540, the selected character string can be deleted.

The user can press a “close” button 541 when the “register”, “edit”, or “delete” work has been completed. If the “close” button 541 is pressed, the screen 525 can be displayed on the operation unit 106.

The screen 525 includes a button group 527 that is operable to set the position of a character string to be added. A user can select the position of a character string to be added using the button group. A print image of the page number associated with the added character string can be displayed at the center according to the selected position.

If the user wants to cancel the character string addition setting, the user can press a “cancel setting” button 530. If the user wants to enable the character string addition setting, the user can press an “OK” button 531. If the “cancel setting” button 530 or the “OK” button 531 is pressed, the screen 516 can be displayed on the operation unit 106.

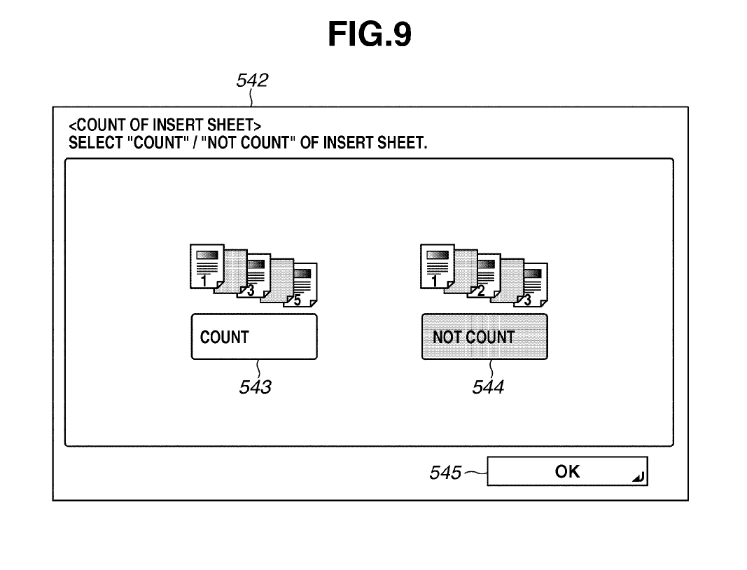

A “count of insert sheet” button 519 is operable to determine whether to count the number of pages of each inserted sheet when an interleaf is inserted according to insert sheet setting. If the “count of insert sheet” button 519 is pressed, a screen 542 illustrated in FIG. 9 can be displayed on the operation unit 106.

The screen 542 illustrated in FIG. 9 includes a “count” button 543 and a “not count” button 544. A user can select anyone of the buttons 543 and 544 to set whether to count the inserted sheet. If the setting is completed, the user can press an “OK” button 545. If the “OK” button 545 is pressed, the setting is enabled and the screen 516 can be displayed on the operation unit 106.

If an “OK” button 550 displayed on the screen illustrated in FIG. 6B is pressed, the screen illustrated in FIG. 6A can be displayed on the operation unit 106.

When the “range designation” button 520 is pressed on the screen 504 illustrated in FIG. 6A, the screen 1703 illustrated in FIG. 10 can be displayed on the operation unit 106. A user can designate from which sheet to which sheet to be printed that are subjected to addition of the page numbers via the screen 1703 illustrated in FIG. 10.

The screen 1703 illustrated in FIG. 10 includes an “all pages” button 1704 that is operable to designate adding page numbers to all sheets to be printed.

A “designated page” button 1705 is operable to designate adding page numbers to arbitrary pages of the sheets to be printed. If the “designated page” button 1705 is pressed, a user can designate sheets on which the page numbers are to be printed in a “designated page range setting” field.

A “start page” button 1706 is operable to designate a page of the print image data from which the page number is to be printed. An initial value of the start page is set beforehand to “1” page (i.e., 1st page). When a user operates the “start page” button 1706, a software keyboard that enables the user to input a numerical value can be displayed on the operation unit 106. Therefore, the user can input a numerical value via the software keyboard and press an OK button on the software keyboard to determine the input numerical value. Further, the user can input a numerical value by operating the numeric keypad 705 in a state where the “start page” button 1706 is selected.

An “until last page” button 1707, a “perform no printing on last page” button 1708, and an “end page” button 1709 are buttons that are usable to set pages of the print image data to which the page numbers are to be printed.

The “until last page” button 1707 is operable to print page numbers to the last page.

The “perform no printing on last page” button 1708 is operable to add page numbers to the last but one.

The “end page” button 1709 is a button that enables a user to designate, by a numerical value, a page of the print image data to which the page number is to be added. More specifically, when a numerical value is designated via the “end page” button 1709, the CPU 201 performs a control so as to allocate (add) page numbers to the start page designated via the “start page” button 1706 to the end page designated via the “end page” button 1709. An initial value of the end page is set beforehand to “1” page (i.e., 1st page). When a user operates the “end page” button 1709, the software keyboard that enables the user to input a numerical value can be displayed on the operation unit 106. Therefore, the user can input a desired numerical value via the software keyboard and press the OK button of the software keyboard to determine the input numerical value. Further, the user can input a numerical value by operating the numeric keypad 705 in a state where the “end page” button 1709 is selected.

A “cancel setting” button 1710 is operable to cancel the content set on the screen 1703 illustrated in FIG. 10 and reopen the screen 504 illustrated in FIG. 6A.

An “OK” button 1711 is operable to register the content set on the screen 1703 illustrated in FIG. 10 and reopen the screen 504 illustrated in FIG. 6A.

The above-described contents which have been effectively set using the screens illustrated in FIGS. 5 to 10 are stored in the DISK 211 so that the CPU 201 can refer to the content.

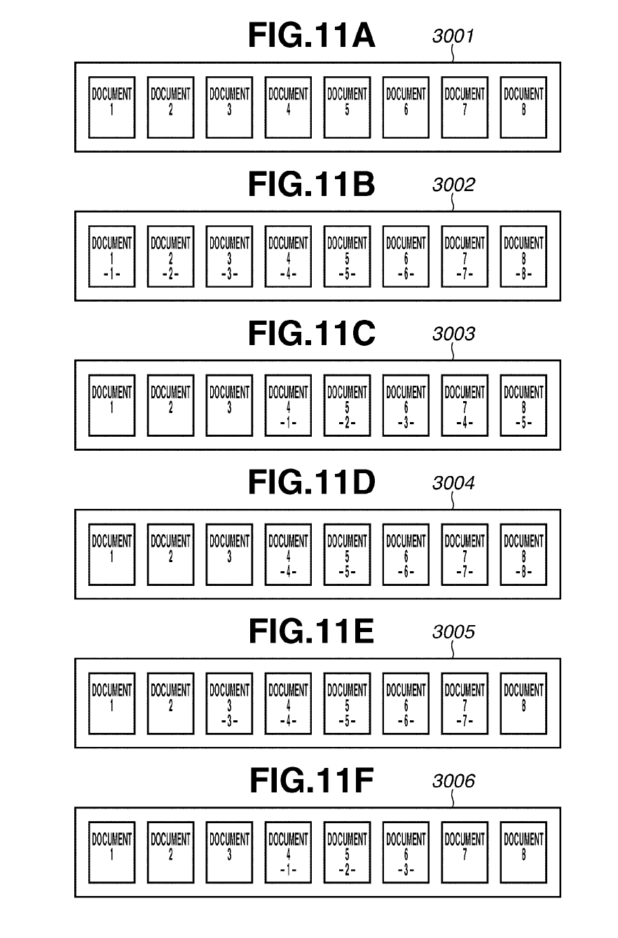

FIGS. 11A to 11F illustrate examples of the page number allocation. The position of each allocated page number is the center of a bottom region. The displayed page number is one digit. The character string addition and the count of insert sheet are set to OFF.

FIG. 11A illustrates image data 3001 (i.e., original image data) to which page numbers are not yet allocated. The image data 3001 can be generated by the scanner unit when the scanner unit reads a document or can be received from an external apparatus.

The image data 3001 includes eight pages of the image data.

FIG. 11B illustrates an example of page numbers to be allocated to the image data 3001 when allocating page numbers to all pages is designated via the “all pages” button 1704 illustrated in FIG. 10 and the value “1” is designated in the “print start number” input area 512 illustrated in FIG. 6A. Image data 3002 includes eight page numbers allocated to all of eight pages of image data.

FIG. 11C illustrates an example of page numbers allocated to the image data 3001 based on the following settings:

the value “1” is designated in the “print start number” input area 512 illustrated in FIG. 6A;

it is designated to allocate page numbers to partial pages via the “designated page” button 1705 illustrated in FIG. 10;

the value “4” is designated via the “start page” button 1706 illustrated in FIG. 10; and

the “until last page” button 1707 illustrated in FIG. 10 is operated. Instead of designating by the “until last page” button 1707, the value “8” may be designated via the “end page” button 1709 illustrated in FIG. 10.

In this case, image data 3003 includes the fourth to eighth pages of image data to which the page numbers “1” to “5” are allocated.

FIG. 11D illustrates an example of page numbers allocated to the image data 3001 based on the following settings:

the value “4” is designated in the “print start number” input area 512 illustrated in FIG. 6A;

it is designated to allocate page numbers to partial pages via the “designated page” button 1705 illustrated in FIG. 10;

the value “4” is designated via the “start page” button 1706 illustrated in FIG. 10; and

the “until last page” button 1707 illustrated in FIG. 10 is operated. Instead of designating by the “until last page” button 1707, the value “8” may be designated via the “end page” button 1709 illustrated in FIG. 10.

In this case, image data 3004 includes the fourth to eighth pages of image data to which the page numbers “4” to “8” are allocated.

If a user does not want to allocate any page numbers to the first to third document pages (for example, when these pages are a front cover, an index page, and an illustration page), the user can obtain a desired output product (see FIG. 11C or FIG. 11D) based on the above-described settings.

FIG. 11E illustrates an example of page numbers allocated to the image data 3001 based on the following settings:

the value “3” is designated in the “print start number” input area 512 illustrated in FIG. 6A;

it is designated to allocate page numbers to partial pages via the “designated page” button 1705 illustrated in FIG. 10;

the value “3” is designated via the “start page” button 1706 illustrated in FIG. 10; and

the “perform no printing on last page” button 1708 illustrated in FIG. 10 is operated. Instead of designating by the “perform no printing on last page” button 1708, the value “7” may be designated via the “end page” button 1709 illustrated in FIG. 10.

If a user does not want to allocate any page numbers to the first and second document pages (for example, when these pages are a front cover, an index page, and an illustration page) and does not want to allocate any page number to the eighth document page (for example, when the last page is aback cover), the user can obtain a desired output product (see FIG. 11E) based on the above-described settings.

FIG. 11F illustrates an example of page numbers allocated to the image data 3001 based on the following settings:

the value “1” is designated is the “print start number” input area 512 illustrated in FIG. 6A;

it is designated to allocate page numbers to partial pages via the “designated page” button 1705 illustrated in FIG. 10;

the value “4” is designated via the “start page” button 1706 illustrated in FIG. 10; and

the value “6” is designated via the “end page” button 1709 illustrated in FIG. 10.

If a user does not want to allocate any page numbers to the first to third document pages (for example, when these pages are a front cover, an index page, and an illustration page) and does not want to allocate any page numbers to the seventh and eighth document pages (for example, when these pages are an illustration page and a back cover), the user can obtain a desired output product (see FIG. 11F) based on the above-described settings.

As described above, according to the present exemplary embodiment, various types of page number printing can be easily realized.

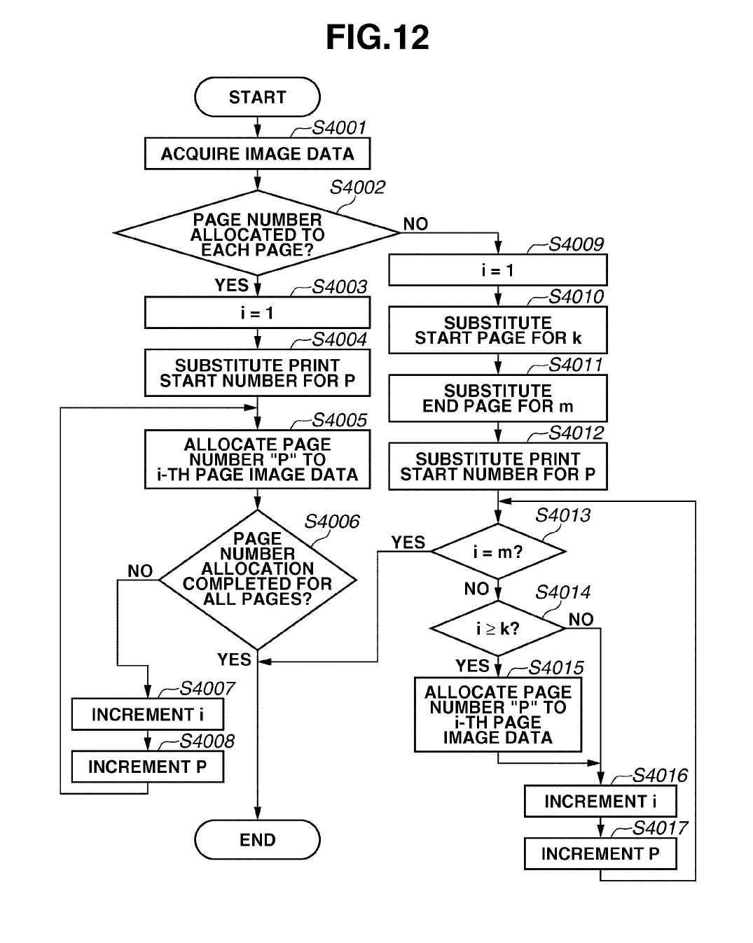

Next, the above-described page number allocation method is described in detail with reference to a flowchart illustrated in FIG. 12. To realize the processing of the flowchart illustrated in FIG. 12, the CPU 201 executes a program loaded from the ROM 210 or the DISK 211.

The CPU 201 starts the processing of the flowchart illustrated in FIG. 12 in response to an image data output instruction from a user.

If a job to be executed is a copy job, the CPU 201 displays an operation screen on the operation unit 106 to receive page output settings. For example, the CPU 201 can display one of the operation screens described with reference to FIGS. 5 to 10 on the operation unit 106 to receive output settings from a user via the operation unit 106. The CPU 201 stores the received settings in the DISK 211. Subsequently, the CPU 201 starts the processing of the flowchart illustrated in FIG. 12 when the user presses the start key 702 of the operation unit 106.

If a job to be executed is a print job, the CPU 201 receives an image data output instruction from the external PC 107. In this case, for example, the user generates image data using application software of the PC 107, launches a printer driver of the PC 107, displays the screens corresponding those illustrated in FIGS. 5 to 10 on a display unit of the PC 107, and performs output settings. In this case, the CPU of the PC 107 stores the output settings received from the user in a memory of the PC 107. If the PC 107 receives a print start instruction via the printer driver, the PC 107 transmits the output settings stored in the memory and image data to the MFP 100. The CPU 201 of the MFP 100 stores the output settings received from the PC 107 in the DISK 211.

If the CPU 201 receives the image data output instruction, then in step S4001, the CPU 201 starts acquiring target image data to be subjected to the page number allocation. If a job to be executed is a copy job, the scanner 102 starts reading an image from a document. Then, the CPU 201 starts acquiring image data generated by the scanner 102. The CPU 201 stores the acquired image data in the DISK 211. If a job to be executed is a print job, the CPU 201 starts receiving image data. The CPU 201 stores the received image data in the DISK 211.

In step S4002, the CPU 201 determines whether to perform page number allocation for all pages or designated pages of the image data acquired in step S4001. If it is determined to perform the page number allocation for all pages of the image data acquired in step S4001 (YES in step S4002), the operation of the CPU 201 proceeds to step S4003. On the other hand, if it is determined to perform the page number allocation for designated pages of the image data acquired in step S4001 (NO in step S4002), the operation of the CPU 201 proceeds to step S4009.

In step S4003, the CPU 201 prepares a variable i in the memory 202 and substitutes an initial value 1 for the variable i.

In step S4004, the CPU 201 prepares a variable P in the memory 202 and substitutes the start number designated in the “print start number” input area 512 for the variable P.

In step S4005, the CPU 201 allocates a page number “P” to an i-th page image data.

In step S4006, the CPU 201 determines whether the processing for allocating page numbers to all pages has been completed. If it is determined that the processing for allocating page numbers to all pages has been completed (YES in step S4006), the CPU 201 terminates the processing of the flowchart illustrated in FIG. 12. On the other hand, if it is determined that the processing for allocating page numbers to all pages is not yet completed (NO in step S4006), the operation of the CPU 201 proceeds to step S4007.

In step S4007, the CPU 201 increments the variable i.

In step S4008, the CPU 201 increments the variable P. Then, the operation returns to step S4005.

Through the processing in steps S4003 to S4008, page numbers can be allocated to all pages of the image data.

On the other hand, when the operation proceeds from step S4002 to step S4009, the CPU 201 performs the following processing.

In step S4009, the CPU 201 prepares the variable i in the memory 202 and substitutes an initial value 1 for the variable i.

In step S4010, the CPU 201 prepares a variable k in the memory 202 and substitutes the start page value designated via the “start page” button 1706 illustrated in FIG. 10 for the variable k.

In step S4011, the CPU 201 prepares a variable m in the memory 202 and substitutes the end page value designated via any one of the buttons 1707 to 1709 illustrated in FIG. 10 for the variable m.

When the operated button is the “until last page” button 1707, the CPU 201 substitutes the last page value of the image data acquired in step S4001 for the variable m. Although the CPU 201 has started acquiring image data in step S4001, the image data acquisition processing may not be thoroughly completed at the timing of step S4011. In such a case, the CPU 201 substitutes the last page currently recognized at the timing of step S4011 for the variable m. Then, the CPU 201 updates the variable m based on the last page value of image data successively acquired while executing subsequent processing.

Further, when the operated button is the “perform no printing on last page” button 1708, the CPU 201 substitutes a value (last page−1) of the image data acquired in step S4001 for the variable m. In this case, although the CPU 201 has started acquiring image data in step S4001, the image data acquisition processing may not be thoroughly completed at the timing of step S4011. In such a case, the CPU 201 substitutes a value obtainable by subtracting 1 from the last page currently recognized at the timing of step S4011 for the variable m. Then, the CPU 201 updates the variable m based on the value (last page−1) of image data successively acquired while executing subsequent processing.

Further, when an end page value is designated via the “end page” button 1709, the CPU 201 substitutes the designated end page value for the variable m.

In step S4012, the CPU 201 prepares the variable P in the memory 202 and substitutes the start number designated in the “print start number” input area 512 for the variable P.

In step S4013, the CPU 201 determines whether the variable i is equal to the variable m. If it is determined that the variable i is equal to the variable m (YES in step S4013), the CPU 201 terminates the processing of the flowchart illustrated in FIG. 12. If it is determined that the variable is not equal to the variable m (NO in step S4013), the operation of the CPU 201 proceeds to step S4014.

In step S4014, the CPU 201 determines whether the variable i is equal to or greater than the variable k. If it is determined that the variable i is equal to or greater than the variable k (YES in step S4014), the operation of the CPU 201 proceeds to step S4015. Whereas if it is determined that the variable i is less than the variable k (NO in step S4014), the operation of the CPU 201 proceeds to step S4016 without executing the processing in step S4015.

In step S4016, the CPU 201 increments the value of the variable i.

In step S4017, the CPU 201 increments the value of the variable P. Then, the operation returns to step S4013.

When the CPU 201 performs the above-described control, page numbers can be easily allocated to specific pages designated by the user among images of a plurality of pages. For example, an output result including allocated page numbers can be obtained using any one of various patterns illustrated in FIGS. 11A to 11F.

Then, if a job to be executed is a copy job, the CPU 201 causes the printer 206 to print an image on a sheet based on image data of a plurality of pages to which page numbers are added according to the above-described method.

Similarly, the present invention is applicable to a scan transmission job that includes allocating page numbers to document image data obtainable when the scanner 208 reads an image from a document and then transmitting the document image data to an external apparatus. Further, the present invention is applicable to a scan storing job that stores document image data generated by reading an image on the document by the scanner 208 in the DISK 211. Further, the present invention is applicable to a BOX print job that allocates page numbers to image data stored in the DISK 211 and print an image on a sheet based on the image data.

According to the first exemplary embodiment of the present invention, a user designates a start page from which a page number is allocated, and page numbers are allocated from the designated start page to the image data of a plurality of pages. Thus, the user can easily allocate page numbers to specific pages that the user wants.

An image processing apparatus according to a second exemplary embodiment enables a user to easily designate a desired start page when the user adds a front cover to image data of a plurality of pages. According to the second exemplary embodiment, it is easy for a user to recognize whether to designate the start page including the front cover or designate the start page without including the front cover when the user adds the front cover to the image data of a plurality of pages.

The second exemplary embodiment is similar to the first exemplary embodiment in system and apparatus configurations and therefore redundant description thereof will be avoided.

First, a cover setting method is described in detail below.

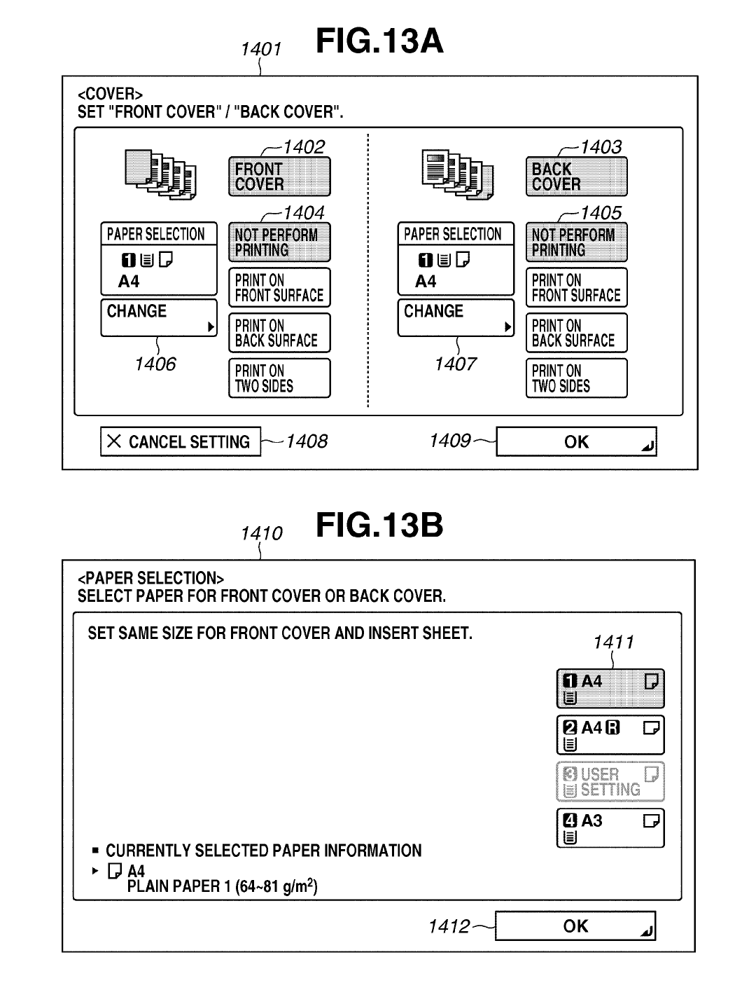

FIG. 13A illustrates a screen 1401 that the CPU 201 can display on the operation unit 106 when the “cover” key 581 illustrated in FIG. 5B is pressed.

The screen 1401 illustrated in FIG. 13A includes a “front cover” button 1402 that is operable to instruct an output of a front cover.

A button group 1404 includes a plurality of buttons that enable a user to determine whether to print an image on the front cover. The user can select any one of “not perform printing”, “print on front surface”, “print on back surface”, and “print on two sides” from the button group 1404. A “change” button 1406 is operable to set a sheet feeding source of a sheet to be used for the front cover. If the “change” button 1406 is pressed, a screen 1410 illustrated in FIG. 13B can be displayed on the operation unit 106.

The screen 1410 illustrated in FIG. 13B includes a button group 1411 that includes a plurality of buttons indicating sheet feeding source candidates for the front cover. The user can operate any button in the button group 1411 to designate a sheet feeding cassette to be the sheet feeding source. If the user presses an OK button 1412 after an appropriate button is selected from the button group 1411, the CPU 201 stores the setting contents in the DISK 211 and terminates the display of the screen 1410 illustrated in FIG. 13B. Then, the CPU 201 displays the screen illustrated in FIG. 13A again on the operation unit 106.

The screen 1401 illustrated in FIG. 13A includes a “back cover” button 1403 that is operable to instruct an output of a back cover.

A button group 1405 includes a plurality of buttons that enable a user to determine whether to print an image on the back cover. The user can select any one of “not perform printing”, “print on front surface”, “print on back surface”, and “print on two sides” from the button group 1405. A “change” button 1407 is operable to set a sheet feeding source of a sheet to be used for the back cover. If the “change” button 1407 is pressed, the screen 1410 illustrated in FIG. 13B can be displayed on the operation unit 106.

The button group 1411 of the screen 1410 illustrated in FIG. 13B can also represent sheet feeding source candidates for a sheet to be used for the back cover. The user can operate any button in the button group 1411 to designate a sheet feeding cassette to be the sheet feeding source. If the user presses the OK button 1412 after an appropriate button is selected from the button group 1411, the CPU 201 stores the setting contents in the DISK 211 and terminates the display of the screen 1410 illustrated in FIG. 13B. Then, the CPU 201 displays the screen illustrated in FIG. 13A again on the operation unit 106.

Next, a method for setting whether to perform designation of a start page on a document basis or on an output paper basis is described in detail below.

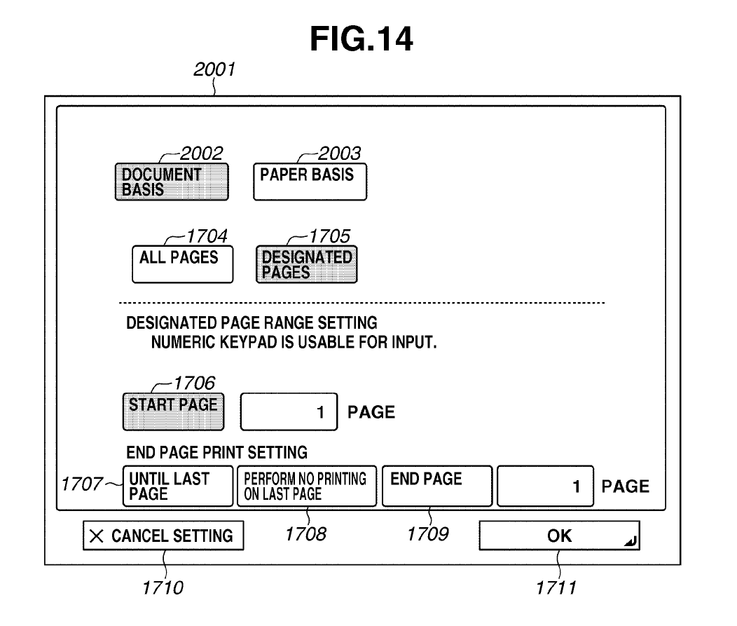

The CPU 201 can display a screen 2001 illustrated in FIG. 14 on the operation unit 106 when the “range designation” button 520 illustrated in FIG. 6A is pressed, instead of displaying the screen 1703 illustrated in FIG. 10.

The screen 2001 illustrated in FIG. 14 includes a “document basis” button 2002 that enables a user to designate allocating page numbers to pages without including the front cover. A “paper basis” button 2003 enables a user to designate allocating page numbers to pages including the front cover.

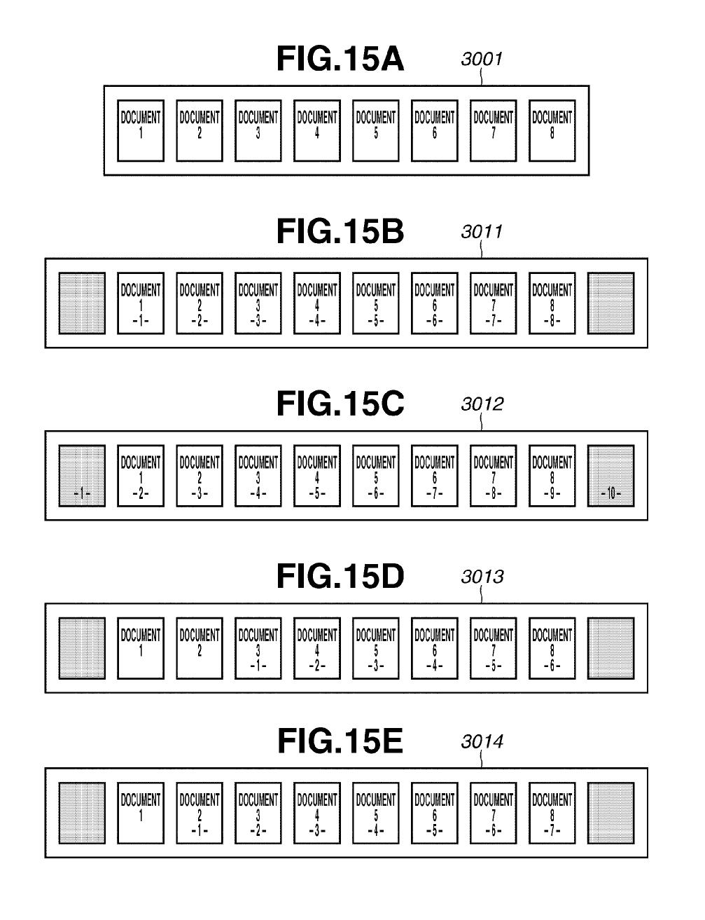

FIGS. 15A to 15E illustrate examples of the page number allocation. The position of each allocated page number is the center of a bottom region. The displayed page number is one digit. The character string addition and the count of insert sheet are set to OFF.

FIG. 15A illustrates original image data 3001 to which page numbers are not yet allocated. The image data 3001 can be generated by the scanner unit when the scanner unit reads a document or can be received from an external apparatus.

The image data 3001 includes eight pages of the image data.

FIGS. 15B to 15E illustrate another image data 3011 to 3014 that can be obtained by adding front and back covers to the image data 3001 according to the operations received via the screen 1401 illustrated in FIG. 13A and the screen 1410 illustrated in FIG. 13B.

FIG. 15B illustrates an example of page numbers to be allocated to the image data 3001 based on the following settings:

the value “1” is designated in the “print start number” input area 512 illustrated in FIG. 6A;

the “document basis” button 2002 illustrated in FIG. 14 is operated; and

it is designated to allocate the page numbers to all pages via the “all pages” button 1704 illustrated in FIG. 14.

In this case, the image data 3011 includes eight pages of the image data to which the page numbers “1” to “8” are allocated without including the front and back covers.

FIG. 15C illustrates an example of page numbers to be allocated to the image data 3001 based on the following settings:

the value “1” is designated in the “print start number” input area 512 illustrated in FIG. 6A;

the “paper basis” button 2003 illustrated in FIG. 14 is operated; and

it is designated to allocate the page numbers to all pages via the “all pages” button 1704 illustrated in FIG. 14.

In this case, the image data 3012 includes eight pages of the image data and the front and back covers to which the page numbers “1” to “10” are allocated.

FIG. 15D illustrates an example of page numbers to be allocated to the image data 3001 based on the following settings:

the value “1” is designated in the “print start number” input area 512 illustrated in FIG. 6A;

the “document basis” button 2002 illustrated in FIG. 14 is operated;

it is designated to allocate page numbers to partial pages via the “designated page” button 1705 illustrated in FIG. 14;

the value “3” is designated via the “start page” button 1706 illustrated in FIG. 14; and

the “until last page” button 1707 illustrated in FIG. 14 is operated. Instead of designating by the “until last page” button 1707, the value “8” may be designated via the “end page” button 1709 illustrated in FIG. 14.

In this case, the image data 3013 includes the third to eighth (i.e., the last) pages of the image data to which the page numbers “1” to “6” are allocated without including the front and back covers

FIG. 15E illustrates an example of page numbers to be allocated to the image data 3001 based on the following settings:

the value “1” is designated in the “print start number” input area 512 illustrated in FIG. 6A;

the “paper basis” button 2003 illustrated in FIG. 14 is operated; and

it is designated to allocate page numbers to partial pages via the “designated page” button 1705 illustrated in FIG. 14;

the value “3” is designated via the “start page” button 1706 illustrated in FIG. 14; and

the “perform no printing on last page” button 1708 illustrated in FIG. 14 is operated. Instead of designating by the “perform no printing on last page” button 1708, the value “9” may be designated via the “end page” button 1709 illustrated in FIG. 14.

In this case, the image data 3014 includes the third to ninth pages to which the page numbers “1” to “7” are allocated including the front and the back covers.

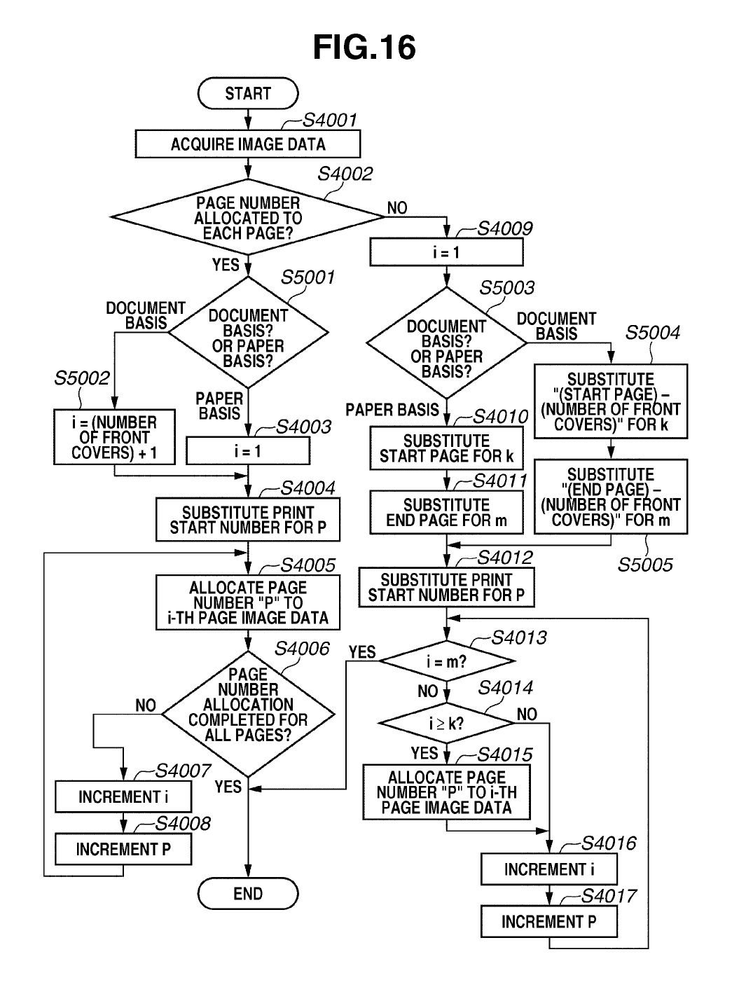

Next, the above-described page number allocation method is described in detail below with reference to a flowchart illustrated in FIG. 16. To realize the processing of the flowchart illustrated in FIG. 16, the CPU 201 executes a program loaded from the ROM 210 or the DISK 211.

The CPU 201 starts the processing of the flowchart illustrated in FIG. 16 in response to an image data output instruction from a user. The flowchart illustrated in FIG. 16 includes processing similar to that described with reference to the flowchart illustrated in FIG. 12 and therefore redundant description thereof will be avoided.

The flowchart illustrated in FIG. 16 is different from the flowchart illustrated in FIG. 12 in that processing to be performed in steps S5001 to S5005 is included.

In step S4002, if it is determined to perform the page number allocation for all pages (YES in step S4002), the operation of the CPU 201 proceeds to step S5001.

In step S5001, the CPU 201 determines whether the button operated on the screen 2001 illustrated in FIG. 14 is the “document basis” button 2002 or the “paper basis” button 2003. If it is determined that the operated button is the “document basis” button 2002, the operation of the CPU 201 proceeds to step S5002. If it is determined that the operated button is the “paper basis” button 2003, the operation of the CPU 201 proceeds to step S4003.

When the operation proceeds to step S5002, the CPU 201 prepares the variable i in the memory 202 and substitutes an initial value that is obtained by adding 1 to the number of front covers set on the screen illustrated in FIG. 13A for the variable i.

When the operation proceeds to step S4003, the CPU 201 prepares the variable i in the memory 202 and substitutes an initial value 1 for the variable i. Subsequently, the CPU 201 performs processing in steps S4004 to S4008. If the “document basis” allocation of page numbers to all pages is designated, the page numbers are allocated as illustrated in FIG. 15B. Further, if the “paper basis” allocation of page numbers to all pages is designated, the page numbers are allocated as illustrated in FIG. 15C.

In step S4009, the CPU 201 prepares the variable i in the memory 202 and substitutes an initial value 1 for the variable i. Then, the operation proceeds to step S5003.

In step S5003, the CPU 201 determines whether the button operated on the screen 2001 illustrated in FIG. 14 is the “document basis” button 2002 or the “paper basis” button 2003. If it is determined that the operated button is the “document basis” button 2002, the operation of the CPU 201 proceeds to step S4010. If it is determined that the operated button is the “paper basis” button 2003, the operation of the CPU 201 proceeds to step S5004.

In step S5004, the CPU 201 prepares the variable k in the memory 202 and substitutes a value obtainable by subtracting the number of front covers set on the screen illustrated in FIG. 13A from the start page designated via the “start page” button 1706 illustrated in FIG. 14 for the variable k.

In step S5005, the CPU 201 prepares the variable m in the memory 202 and substitutes a value obtainable by subtracting the number of front covers set on the screen illustrated in FIG. 13A from the end page value designated via any one of the buttons 1707 to 1709 illustrated in FIG. 14 for the variable m. If the “until last page” button 1707 is operated, the CPU 201 substitutes the last page value of the image data acquired in step S4001 for the variable m. Although the CPU 201 has started acquiring image data in step S4001, the image data acquisition processing may not be thoroughly completed at the timing of step S4011. In such a case, the CPU 201 substitutes the last page currently recognized at the timing of step S4011 for the variable m. Then, the CPU 201 updates the variable m based on the last page value of image data successively acquired while executing subsequent processing.

Further, when the operated button is the “perform no printing on last page” button 1708, the CPU 201 substitutes the value (last page−1) of the image data acquired in step S4001 for the variable m. In this case, although the CPU 201 has started acquiring image data in step S4001, the image data acquisition processing may not be thoroughly completed at the timing of step S4011. In such a case, the CPU 201 substitutes a value obtainable by subtracting 1 from the last page currently recognized at the timing of step S4011 for the variable m. Then, the CPU 201 updates the variable m based on the value (last page−1) of image data successively acquired while executing subsequent processing.

Further, when an end page value is designated via the “end page” button 1709, the CPU 201 substitutes the designated end page value for the parameter m.

Then, the operation of the CPU 201 proceeds to step S4012. Subsequently, the CPU 201 performs processing in steps S4012 to S4017.

When the CPU 201 performs the above-described control, page numbers can be easily allocated to specific pages designated by the user, among images of a plurality of pages even when the front cover is added. For example, an output result including allocated page numbers can be obtained using any one of various patterns illustrated in FIGS. 15A to 15E.

Then, if a job to be executed is a copy job, the CPU 201 causes the printer 206 to print an image on a sheet based on image data of a plurality of pages to which page numbers are allocated according to the above-described method.

According to the above-described exemplary embodiment, an example of insertion of an interleaf is not described in detail. However, the exemplary embodiment may be configured to allow a user to perform detailed settings for the interleaf.

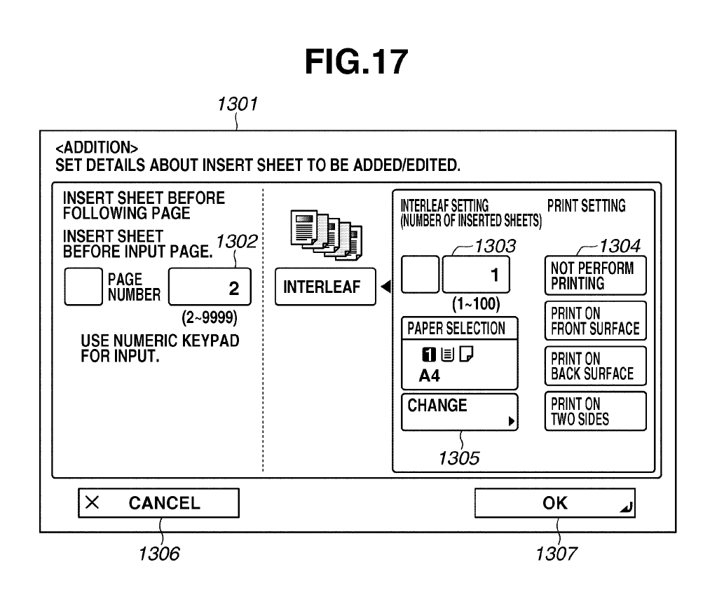

For example, if the “insert” key 582 of the screen illustrated in FIG. 5B is pressed, the CPU 201 causes the operation unit 106 to display a screen 1301 illustrated in FIG. 17.

The screen 1301 illustrated in FIG. 17 includes a “page number” button 1302 that enables a user to designate the position of an interleaf to be inserted. The user can designate the position of each interleaf to be inserted by pressing the “page number” button 1302 and inputting a numerical value using the numeric keypad 705. If the numerical value “2” is input by the user and a setting for not perform printing on the interleaf is designated, the CPU 201 performs setting so as to insert the interleaf between a sheet on which an image of the second document page is printed and a preceding sheet on which an image is printed. On the other hand, if the numerical value “2” is input by the user and a setting for perform printing on the interleaf is designated, the CPU 201 performs setting so as to print an image of the second document page on the interleaf. Then, the CPU 201 performs setting so as to insert the interleaf between a sheet on which an image of the first document page is printed and a sheet on which an image of the third document page is printed.

A button 1303 is operable to designate the number of interleaves to be inserted at the position designated via the “page number” button 1302. A user can designate the number of interleaves to be inserted at the position designated via the “page number” button 1302 by pressing the button 1303 and inputting the number of interleaves to be inserted via the numeric keypad 705.

A button group 1304 includes a plurality of buttons that enable a user to determine whether to print a document image on the interleaf.

The user can select anyone of “not perform printing”, “print on front surface”, “print on back surface”, and “print on two sides” from the button group 1304.

A “change” button 1305 is operable to set a sheet feeding source of a sheet to be used for the interleaf. If the “change” button 1305 is pressed, the screen 1410 illustrated in FIG. 13B can be displayed on the operation unit 106. The button group 1411 of the screen 1410 illustrated in FIG. 13B can also represent sheet feeding source candidates that are selectable for a sheet to be used for the interleaf. The user can operate any button in the button group 1411 to designate a sheet feeding cassette to be the sheet feeding source. If the user presses the OK button 1412 after an appropriate button is selected from the button group 1411, the CPU 201 stores the setting contents in the DISK 211 and terminates the display of the screen 1410 illustrated in FIG. 13B. Then, the CPU 201 displays the screen illustrated in FIG. 17 again on the operation unit 106.

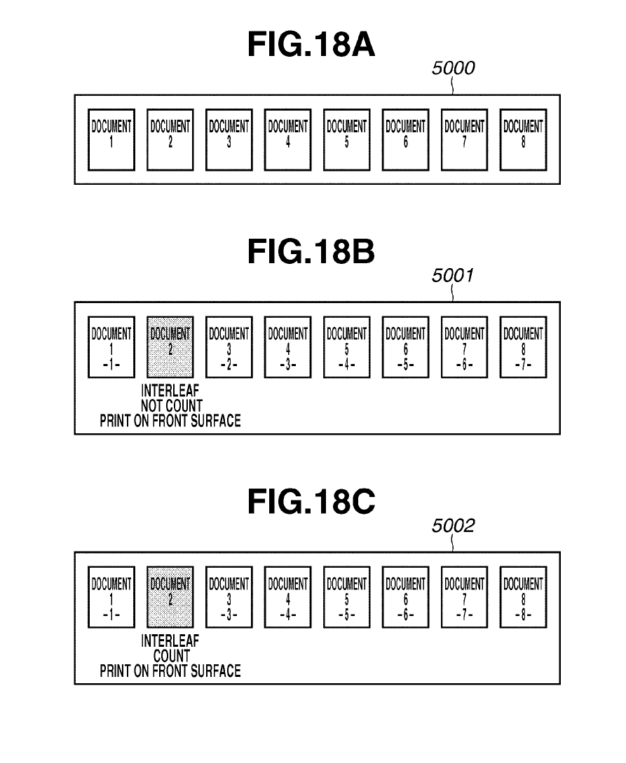

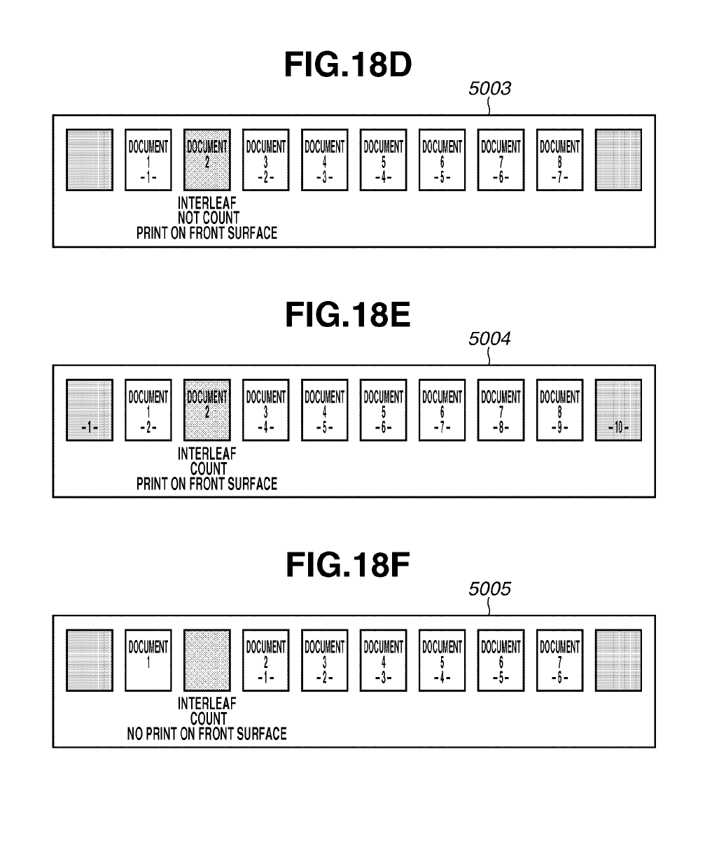

FIGS. 18A to 18F illustrate examples of the page number allocation in a case where an interleaf is inserted.

The position of each allocated page number is the center of a bottom region. The displayed page number is one digit. The character string addition and the count of insert sheet are set to OFF.

FIG. 18A illustrates original image data 5000 to which page numbers are not yet allocated. The image data 5000 can be generated by the scanner unit when the scanner unit reads a document or can be received from an external apparatus.

The image data 5000 includes eight pages of the image data.

FIG. 18B to 18E illustrate image data 5001 to 5005 that can be obtained by adding an interleaf to the image data 5000 according to the operations received via the screen 1301 illustrated in FIG. 17 and the screen 1410 illustrated in FIG. 13B.

FIG. 18B illustrates an example of page numbers to be allocated to the image data 5000 based on the following settings:

the value “1” is designated in the “print start number” input area 512 illustrated in FIG. 6A;

it is designated to allocate the page numbers to all pages via the “all pages” button 1704 illustrated in FIG. 14.

the value “2” is designated via the “page number” button 1302 illustrated in FIG. 17;

the value “1” is designated via the “interleaf setting” button 1303 illustrated in FIG. 17;

the “not count” button 544 illustrated in FIG. 9 is operated; and

the option “print on front surface” is designated in the button group 1304 illustrated in FIG. 17.

In this case, the image data 5001 includes seven pages of the image data to which page numbers are allocated without including the interleaf to which no page number is allocated. More specifically, the CPU 201 allocates the page number “1” to the first page of the image data and allocates the page number “2” to the third page of the image data, without counting the interleaf that corresponds to the second page of the image data.

FIG. 18C illustrates an example of page numbers to be allocated to the image data 5000 based on the following settings:

the value “1” is designated in the “print start number” input area 512 illustrated in FIG. 6A;

it is designated to allocate the page numbers to all pages via the “all pages” button 1704 illustrated in FIG. 14.

the value “2” is designated via the “page number” button 1302 illustrated in FIG. 17;

the value “1” is designated via the “interleaf setting” button 1303 illustrated in FIG. 17;

the “count” button 543 illustrated in FIG. 9 is operated; and

the option “print on front surface” is designated in the button group 1304 illustrated in FIG. 17.

In this case, the image data 5002 includes seven pages of the image data to which page numbers are allocated without including the interleaf to which no page number is allocated. More specifically, the CPU 201 allocates the page number “1” to the first page of the image data and allocates the page number “3” to the third page of the image data, while counting the interleaf that corresponds to the second page of the image data.

Next, another examples of the page number allocation, which can be performed when a user wants to insert a front cover, a back cover, and an interleaf, are described below.

FIG. 18D illustrates an example of page numbers to be allocated to the image data 5000, when insertion of the front cover and the back cover is set, based on the following settings:

the value “1” is designated in the “print start number” input area 512 illustrated in FIG. 6A;

the “document basis” button 2002 illustrated in FIG. 14 is operated;

it is designated to allocate the page numbers to all pages via the “all pages” button 1704 illustrated in FIG. 14.

the value “2” is designated via the “page number” button 1302 illustrated in FIG. 17;

the value “1” is designated via the “interleaf setting” button 1303 illustrated in FIG. 17;

the “not count” button 544 illustrated in FIG. 9 is operated; and

the option “print on front surface” is designated in the button group 1304 illustrated in FIG. 17.

In this case, the image data 5003 includes seven pages of the image data to which page numbers are allocated without including the front and back covers and the interleaf to which no page numbers are allocated. More specifically, the CPU 201 allocates the page number “1” to the first page of the image data and the page number “2” to the third page of the image data, without counting the interleaf that corresponds to the second page of the image data.

FIG. 18E illustrates an example of page numbers to be allocated to the image data 5000, when insertion of the front cover and the back cover is set, based on the following settings:

the value “1” is designated in the “print start number” input area 512 illustrated in FIG. 6A;

the “paper basis” button 2002 illustrated in FIG. 14 is operated;

it is designated to allocate the page numbers to all pages via the “all pages” button 1704 illustrated in FIG. 14.

the value “2” is designated via the “page number” button 1302 illustrated in FIG. 17;

the value “1” is designated via the “interleaf setting” button 1303 illustrated in FIG. 17;

the “count” button 543 illustrated in FIG. 9 is operated; and

the option “print on front surface” is designated in the button group 1304 illustrated in FIG. 17.

In this case, the image data 5004 includes nine pages of the image data to which page numbers are allocated without including the interleaf to which no page number is allocated. More specifically, the CPU 201 allocates the page number “1” to the front cover, the page number “2” to the first document page, and the page number “4” to the third document page, while counting the interleaf.

FIG. 18F illustrates an example of page numbers to be allocated to the image data 5000 based on the following settings:

the value “1” is designated in the “print start number” input area 512 illustrated in FIG. 6A;

the “document basis” button 2002 illustrated in FIG. 14 is operated;

it is designated to allocate page numbers to partial pages via the “designated page” button 1705 illustrated in FIG. 14;

the value “2” is designated via the “start page” button 1706 illustrated in FIG. 14;

the “until last page” button 1707 illustrated in FIG. 14 is operated; or instead of designating by the “until last page” button 1707, the value “8” may be designated via the “end page” button 1709 illustrated in FIG. 14;

the value “2” is designated via the “page number” button 1302 illustrated in FIG. 17;

the value “1” is designated via the “interleaf setting” button 1303 illustrated in FIG. 17;

the “count” button 543 illustrated in FIG. 9 is operated; and

the option “not perform printing on front surface” is designated in the button group 1304 illustrated in FIG. 17.

In this case, the image data 5005 includes the second to seventh document pages of the image data to which the page numbers “1” to “6” are allocated without including the front and back covers and the interleaf to which no page numbers are allocated.

As described above, the image processing apparatus according to the present exemplary embodiment enables a user to perform flexible settings with respect to the page number allocation for an interleaf.

Although no page number is allocated to the interleaf in the above-described embodiment, a user is allowed to allocate a page number to the interleaf. In this case, the CPU 201 may perform control to allocate a page number to the interleaf if the page number allocation is set and not to allocate any page number if the page number allocation is not set.

Further, according to the above-described exemplary embodiments, the MFP 100 performs various settings and control processing based on user instructions received via screens displayed on the operation unit 106. However, the present invention is not limited to the above-described examples. For example, the above-described screens may be displayed on a display unit of the external PC 107. In this case, the external PC 107 transmits settings to the MFP 100 if the settings are received via the screens. The MFP 100 thus performs various settings and control processing according to the received settings.

In the present invention, a job to be executed is not limited to a copy job. For example, the present invention is applicable to a scan transmission job that includes allocating page numbers to document image data obtained when the scanner 208 reads an image from a document and then transmitting the document image data to an external apparatus. Further, the present invention is applicable to a scan storing job that includes storing, in the DISK 211, document image data obtained when the scanner 208 reads an image from a document. Further, the present invention is applicable to a BOX print job that includes allocating page numbers to image data stored in the DISK 211 and printing an image on a sheet based on the image data.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-100973 filed Apr. 26, 2012, which is hereby incorporated by reference herein in its entirety.

What is claimed is:

1. An image processing apparatus for processing images of a plurality of pages, the image processing apparatus comprising:
a first determining unit configured to determine a start page of page number from the plurality of pages according to a user instruction;
a second determining unit configured to determine an end page of the page number from the plurality of pages according to a user instruction; and
a control unit configured to perform control to add the page number based on the start page determined by the first determining unit and the end page determined by the second determining unit.

2. The image processing apparatus according to claim 1, further comprising:
a specifying unit configured to specify a page number to be added to the start page determined by the first determining unit according to a user instruction,
wherein the control unit is configured to add the page number specified by the specifying unit and subsequent page numbers from the start page designated by the first determining unit to the end page determined by the second determining unit.

3. The image processing apparatus according to claim 1, further comprising:
a cover adding unit configured to add a cover to the images of the plurality of pages; and
a setting unit configured to determine whether to count or not the cover added by the cover adding unit in determining the start page to be determined by the first determining unit.

4. The image processing apparatus according to claim 1, further comprising:
an insert sheet adding unit configured to add an insert sheet to the images of the plurality of pages; and
a setting unit configured to determine whether to count or not the insert sheet added by the insert sheet adding unit in determining the start page to be determined by the first determining unit.

5. The image processing apparatus according to claim 1, wherein the second determining unit is configured to cause a user to select a last page, or a page preceding the last page, as the end page of the page number, and determine the end page selected by the user as a page number termination page.

6. The image processing apparatus according to claim 1, further comprising:
a printing unit configured to print a page to which the page number is added.

7. The image processing apparatus according to claim 1, further comprising:
a sending unit configured to send a page to which the page number is added to an external apparatus.

8. The image processing apparatus according to claim 1, further comprising:
a reading unit configured to read a document,
wherein the reading unit reads the document and the images of the plurality of pages can be obtained.

9. An image processing apparatus for processing images of a plurality of pages, the image processing apparatus comprising:
a determining unit configured to determine a start page of page number from the plurality of pages according to a user instruction;
a specifying unit configured to specify a page number to be added to the start page determined by the determining unit according to a user instruction; and
a control unit configured to perform control to add the page number specified by the specifying unit and subsequent page numbers to the start page determined by the determining unit and subsequent pages.

10. A method for controlling an image processing apparatus for processing images of a plurality of pages, the method comprising:
determining a start page of page number from the plurality of pages according to a user instruction;
determining an end page of the page number from the plurality of pages according to a user instruction; and
performing a control to add page numbers based on the start page and the end page.

11. A non-transitory computer readable storage medium storing a computer program for controlling an image processing apparatus that processes images of a plurality of pages, the computer program comprising:
a code to determine a start page of page number from the plurality of pages according to a user instruction;
a code to determine an end page of the page number from the plurality of pages according to a user instruction; and
a code to perform control to add page numbers based on the start page and the end page.
